(19) United States
(12) Patent Application Publication
(10) Pub. No.: US 2025/0117983 A1
(43) Pub. Date: Apr. 10, 2025

(54) COLOR REPRODUCTION DEVICE WITH COLOR-BLINDNESS MITIGATION AND METHODS FOR USE THEREWITH

(71) Applicants: Lawrence P. Huang, Austin, TX (US); Bruce E. Stuckman, Austin, TX (US)

(72) Inventors: Lawrence P. Huang, Austin, TX (US); Bruce E. Stuckman, Austin, TX (US)

(21) Appl. No.: 18/888,439

(22) Filed: Sep. 18, 2024

Related U.S. Application Data
(60) Provisional application No. 63/589,169, filed on Oct. 10, 2023.

(51) Int. Cl. G06T 11/00

(52) U.S. Cl. CPC G06T 11/001; G06T 2200/24

(57) ABSTRACT

A color reproduction device operates by iteratively training a color processing subsystem, wherein the iterative training includes the steps of: color processing at least one color-blindness test image based on color processing parameters to produce at least one processed color-blindness test image; displaying the at least one processed color-blindness test image to a user via the display device; receiving user feedback via the interactive user interface; adjusting the color processing parameters based on the user feedback; repeating the prior step via a plurality of iterations until a termination criterion is met; and storing final color processing parameters when the termination criterion is met; receiving color images for display; and color processing the color images based on the final color processing parameters to produce processed color images for display.

### CROSS REFERENCE TO RELATED APPLICATIONS

The present U.S. Utility Patent Application claims priority pursuant to 35 U.S.C. § 119(e) to U.S. Provisional Application No. 63/589,169, entitled “COLOR REPRODUCTION DEVICE WITH COLOR-BLINDNESS MITIGATION AND METHODS FOR USE THEREWITH”, filed Oct. 10, 2023, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND

### Technical Field

This invention relates generally to color processing systems used in conjunction with display devices.

### DESCRIPTION OF RELATED ART

### Brief Description of the Several Views of the Drawing(s)

The patent or application file contains at least one drawing executed in color. Copies of this patent or patent application publication with color drawing(s) will be provided by the Office upon request and payment of the necessary fee.

FIG. 1 is a pictorial/block diagram of an example a color reproduction device in accordance with various embodiments;

FIG. 2 is a schematic block diagram of an example color reproduction device in accordance with various embodiments;

FIG. 3A is a block/flow diagram of an example portion of a color reproduction device in accordance with various embodiments;

FIG. 3B is a block/flow diagram of an example portion of a color processing subsystem in accordance with various embodiments;

FIG. 3C is a block/flow diagram of an example portion of a color processing subsystem in accordance with various embodiments;

FIG. 3D is a pictorial representation of example screen displays in accordance with various embodiments;

FIG. 3E is a block/flow diagram of an example portion of a color reproduction device in accordance with various embodiments;

FIG. 4A is a graphical diagram of the color spectrum in accordance with various embodiments;

FIG. 4B is a graphical diagram of the color spectrum in accordance with various embodiments;

FIG. 5 is a flow diagram of an example method in accordance with various embodiments.

FIGS. 6A-6C are pictorial representations of portions of example screen displays in accordance with various embodiments.

### DETAILED DESCRIPTION

One or more embodiments are now described with reference to the drawings, wherein like reference numerals are used to refer to like elements throughout. In the following description, for purposes of explanation, numerous details are set forth in order to provide a thorough understanding of the various embodiments. It is evident, however, that the various embodiments can be practiced without these details and without applying to any particular networked environment, computer architecture, processing system or standard.

Color can be an integral part of people's lives, shaping their experiences and influencing their emotions. However, for some individuals, the world is perceived differently due to a condition known as color blindness. In particular, color blindness, also known as color vision deficiency, is a condition that affects an individual's ability to perceive certain colors or distinguish between them. While most people see the world in a vast array of colors, those with color blindness may have difficulty perceiving specific colors or interpreting color differences accurately.

Color blindness is primarily caused by genetic mutations or inherited traits. These mutations affect the specialized cells in the retina called cone cells, which are responsible for color perception. There are three types of cones, each sensitive to different wavelengths of light: e.g., (red, green, and blue), (long, medium and short), etc. Color blindness occurs when one or more of these cone cells are faulty or absent. The most prevalent types of color blindness are red-green color blindness and blue-yellow color blindness. Red-green color blindness, as the name suggests, affects the perception of red and green colors. People with this type of color blindness may struggle to differentiate between red and green shades, often perceiving them as similar or even identical. Blue-yellow color blindness, on the other hand, affects the perception of blue and yellow colors. Individuals with this type of color blindness may have difficulty distinguishing between blue and yellow hues.

Color blindness can have various effects on an individual's daily life. In some cases, it may pose challenges in activities that heavily rely on color perception, such as reading color-coded charts or maps, identifying traffic lights, or even selecting matching clothes. Additionally, color-blind individuals may face difficulties in certain professions, such as graphic design, art, or electrical wiring, where accurate color perception is essential. The various embodiments presented herein improve the technology of color processing systems that generate or store color images for display by color display devices (and/or the color display devices themselves) by processing colors to mitigate the effects of color-blindness in a fashion that is specific to the color perceptions of a particular viewer.

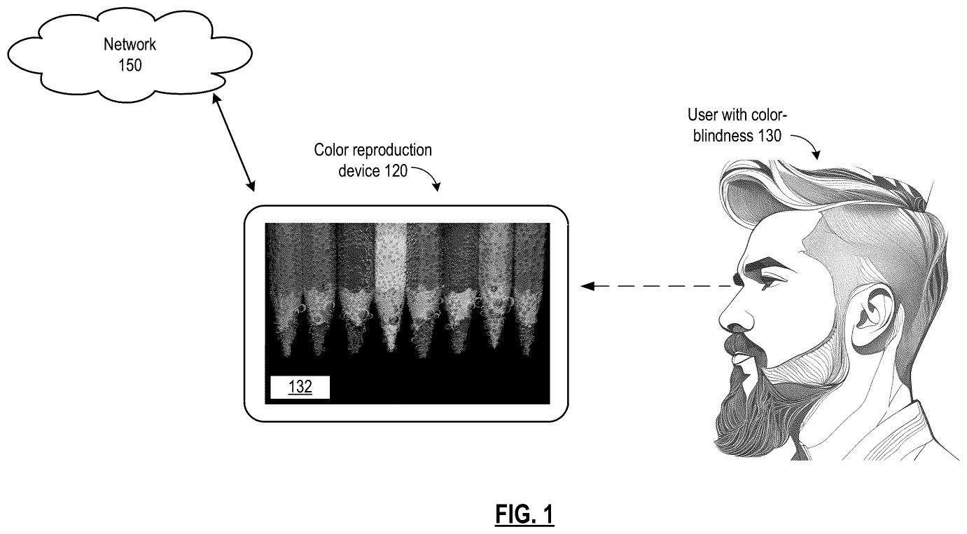

FIG. 1 presents a color reproduction device 120 that can communicate bidirectionally with a wired and/or wireless network 150. Network 150 can include one or more wireless, optical and/or wired communication systems; one or more non-public intranet systems and/or public Internet systems; and/or one or more local area networks (LAN) and/or wide area networks (WAN). The color reproduction device 120 can be implemented via a television, smart television, computer monitor, screen projector, smartphone, tablet, laptop, virtual reality (VR) glasses, alternative reality (AR) glasses and/or other display device capable of displaying color images. The color reproduction device 120 can include one or more applications (apps) such as a browser, social media app(s), video playback apps, a camera app, photo app and is configured to download, stream, store and/or play media files that include text, color graphics, video and still images and other color imagery. In particular, the color reproduction device 120 can be configured to display color images via one or more screen displays 132 (either internal or external to the device) that are color processed to mitigate the effects of color-blindness in a fashion that is specific to the color perceptions of a particular user with color blindness 130.

In various examples, the color reproduction device 120 includes a display device, an interactive user interface or other input device, at least one processing system that includes a processor, and at least one memory including a non-transitory computer readable storage medium that stores executable instructions corresponding to a color-blindness mitigation application that, when executed by the at least one processing system, cause performance of operations that include:
iteratively training a color processing subsystem, wherein the iterative training includes the steps of:
   (a) color processing at least one color-blindness test image based on color processing parameters to produce at least one processed color-blindness test image;
   (b) displaying the at least one processed color-blindness test image to a user via the display device;
   (c) receiving user feedback via the interactive user interface or other input device;
   (d) adjusting the color processing parameters based on the user feedback;
   (e) repeating steps (a)-(d) via a plurality of iterations until a termination criterion is met; and
   (f) storing final color processing parameters when the termination criterion is met;
receiving color images for display;
color processing the color images based on the final color processing parameters to produce processed color images for display.

In addition or in the alternative to any of the foregoing, the color processing operates via digital compensation of a visible spectrum and wherein the color processing parameters include digital compensation parameters.

In addition or in the alternative to any of the foregoing, the color processing operates via a plurality of color compensation engines and wherein the color processing parameters include compensation parameters corresponding to the plurality of color compensation engines.

In addition or in the alternative to any of the foregoing, the plurality of color compensation engines include a blue compensation engines, a red compensation engines and a green compensation engines and wherein the compensation parameters include gains corresponding to the blue compensation engines, the red compensation engines and the green compensation engines.

In addition or in the alternative to any of the foregoing, the plurality of color compensation engines include a notch compensation engines and wherein the compensation parameters include a notch frequency and a notch bandwidth corresponding to the notch compensation engines.

In addition or in the alternative to any of the foregoing, color processing parameters are adjusted by selecting a next set of color processing parameters in a predetermined sequence of color processing parameters.

In addition or in the alternative to any of the foregoing, the color processing parameters are adjusted utilizing a search algorithm.

In addition or in the alternative to any of the foregoing, the termination criterion includes reaching a maximum iteration count.

In addition or in the alternative to any of the foregoing, the user feedback includes a score and wherein the termination criterion includes comparing the score to a threshold.

In addition or in the alternative to any of the foregoing, the user feedback includes a plurality of scores for the plurality of iterations and wherein the final color processing parameters correspond to the color processing parameters for one of the plurality of iterations yielding a most favorable score of the plurality of scores.

In addition or in the alternative to any of the foregoing, the color processing operates via one or more neural networks.

In addition or in the alternative to any of the foregoing, adjusting the color processing parameters includes sweeping a frequency window over a range of visible frequencies.

Further examples including many optional functions and features of the color reproduction device 120 are described in conjunction with the Figures that follow.

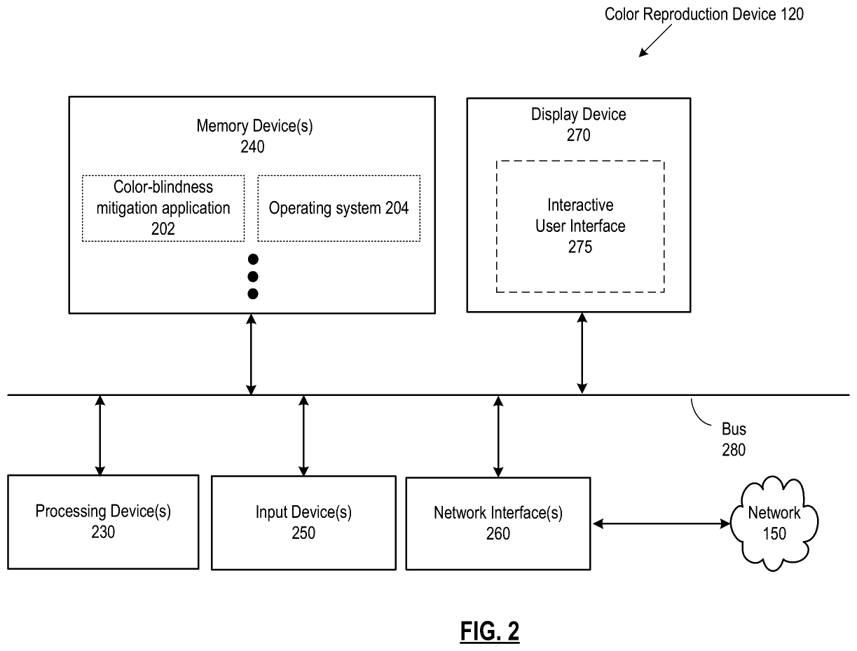

FIG. 2 presents an example of a color reproduction device 120 in accordance with various embodiments. The color reproduction device 120 includes one or more mobile processing devices 230 that each include a processing circuit, one or more mobile memory devices 240, one or more mobile input devices 250, one or more mobile network interfaces 260 operable to more support one or more communication links via the network 150 indirectly and/or directly and/or to connect to an external display device, and/or an internal display device 270 such as touch screen monitor or other display, connected via bus 280. While a particular bus structure is shown for purposes of illustration in a block diagram, other structures include multiple buses and/or direct connections between functional blocks. The memory device(s) 240 can store an operating system 204, color-blindness mitigation application 202 along with other applications, data, media files, etc.

In various embodiments, executable instructions included in an operating system 204, color-blindness mitigation application 202 and/or other application, utility or routine, when executed by the processing device 230, facilitate the performance of the operations by the color reproduction device 120. In particular, one or more processing devices 230 can generate an interactive interface 275 on the one or more mobile display devices 270 in accordance with the color-blindness mitigation application 202. The user can provide input in response to menu data, selectable links, prompts and/or other media presented by the interactive interface via the one or more client input devices 250. The input devices 250 can include a microphone, mouse, keyboard, touchscreen of display device 270 itself or other touchscreen, and/or other device allowing the user to interact with the interactive interface 275. The one or more processing devices 230 can receive and/or generate new data for presentation via the interactive interface 275 and/or utilizing network interface 260 to communicate bidirectionally via the network 150.

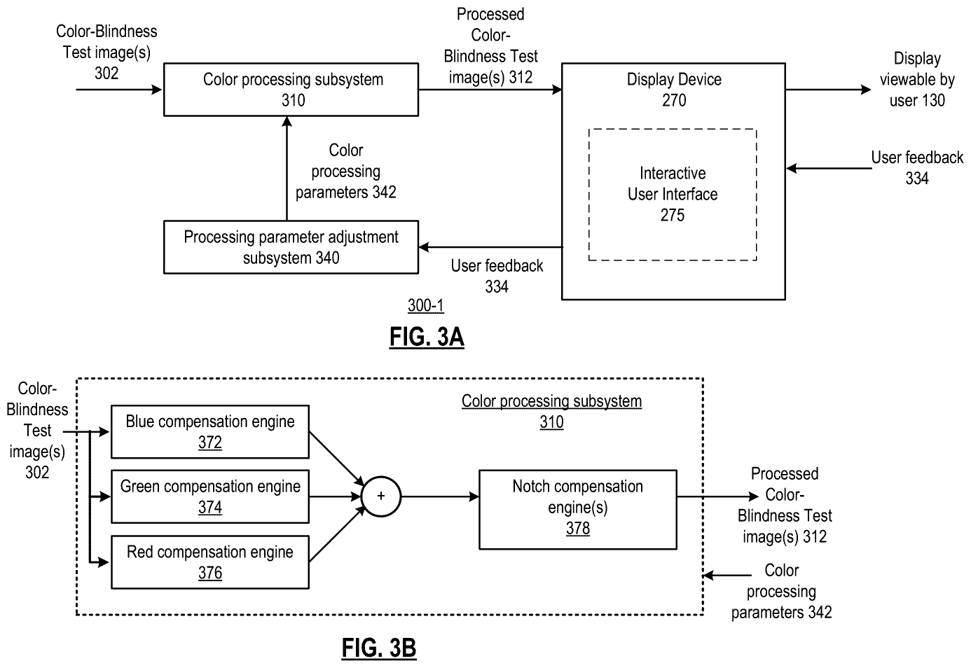

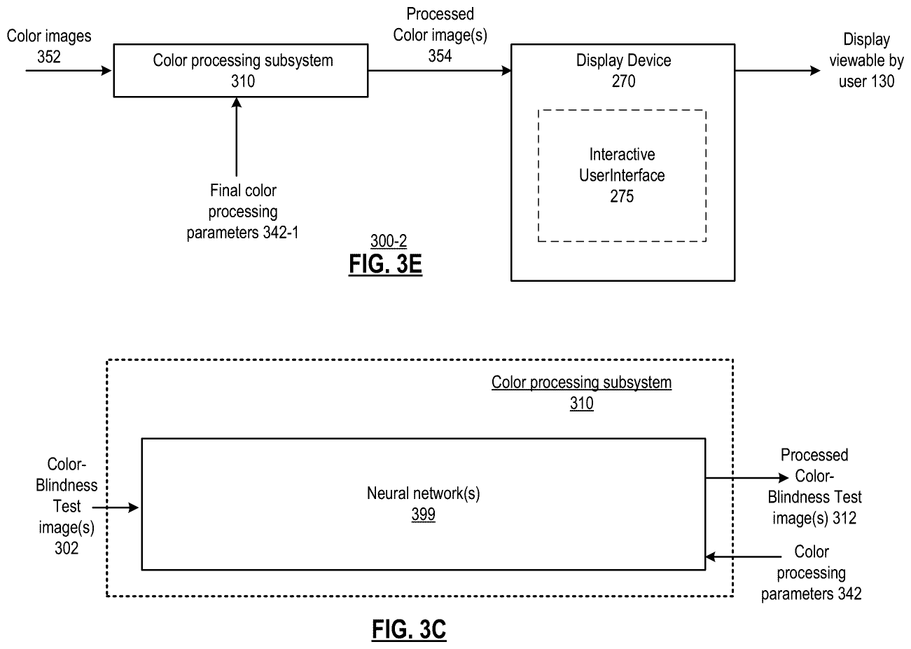

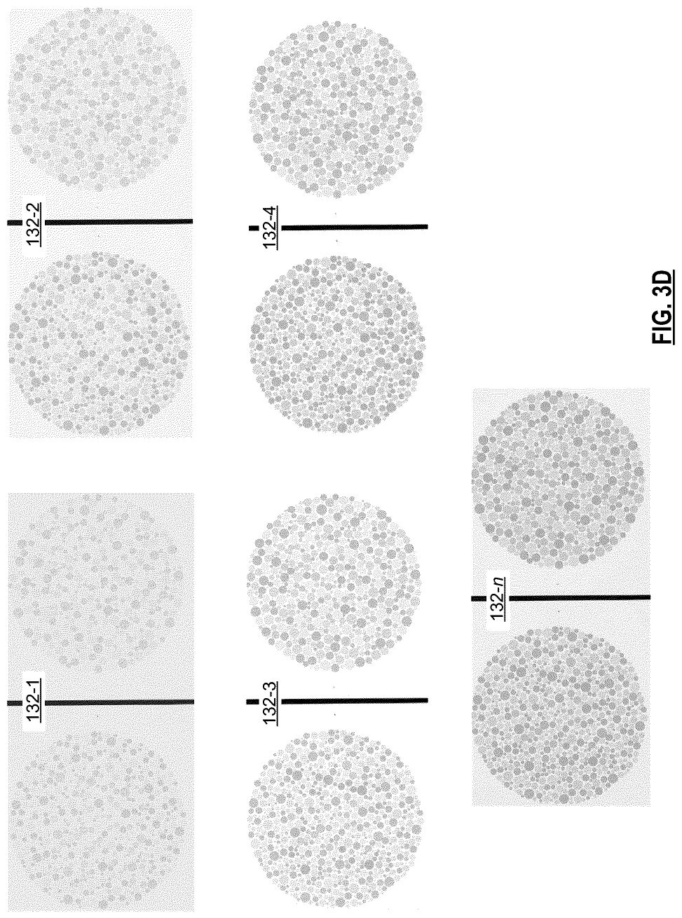

FIG. 3A is a block/flow diagram of an example portion 300-1 of a color reproduction device in accordance with various embodiments. The portion shown includes a color processing subsystem 310 and a processing parameter adjustment subsystem 340 that each can be implemented via operational instructions stored in the memory device(s) 240 and executed by the processing device(s) 230. In various embodiments, the color processing subsystem 310 operates based on color processing parameters 342 selected by the processing parameter adjustment subsystem 340 to iteratively train the color processing subsystem 310 based user feedback 334 from a particular user with color-blindness.

In an example of such training, the color processing subsystem 310 processes color-blindness test image(s) based on color processing parameters 342 selected by the processing adjustment subsystem 340 to produce processed color-blindness test image(s) 312 that are displayed, via display device 270, so as to be viewable by the user 130 who generates user feedback 334 via the interactive user interface 275 and/or the input device(s). The processing parameter adjustment system 340 then adjusts the color processing parameters 342 based on the user feedback 342 and the iterative training process is repeated until a termination criterion is met, at which point a set of final color processing parameters 342 are stored.

In various examples, the color-blindness test image(s) 302 includes color blindness test pattern(s) from the Ishihara test. These consist of a series of plates that contain circles filled with dots in different colors and sizes. Each image has a hidden number or pattern that individuals with normal color vision can easily identify, while those with color blindness might struggle to see or correctly identify it. In addition or in the alternative, the color-blindness test image(s) 302 includes color blindness test pattern(s) from the Farnsworth-Munsell 100 Hue Test. This test requires individuals to arrange color tiles in a specific order based on their hue and helps determine the type and severity of color vision deficiency by analyzing the errors made during the arrangement. Other color-blindness test image(s) 312 can be used as well. The user feedback 334 can include a user score such as a test result, a comparison to the last display such as “better” or “worse” and/or other indication of how well (or if) one or more colors or images are distinguishable.

In various examples, the color processing subsystem 310 operates via digital compensation of a visible spectrum and the color processing parameters 342 include digital compensation parameters that result in the particular compensation applied to the frequencies in the visible spectrum. This digital compensation can be performed via one or more individual compensation engines such as a blue compensation engine 372, a green compensation engine 374, a red compensation engine 376, one or more notch compensation engines 378, etc., each having individual compensation parameters such as a gain, center frequency and/or bandwidth as shown, for example, in FIG. 3B. In various embodiments, each of these compensation engines can be implemented by filter such as a lowpass filter, highpass filter, bandpass filter, notch filter or other filter, each having adjustable parameters that correspond to the individual compensation parameters. Alternatively, the gains at a plurality of different frequencies across the visible spectrum can be themselves assigned as individual digital compensation parameters. For example, the amplitude and/or phase of a frequency components of each frequency of a discrete Fourier transform (DFT) can be individually adjusted to generate a customized color compensation over the visible spectrum.

In various examples, the processing parameter adjustment subsystem 340 operates by selecting a next set of color processing parameters 342 in a predetermined sequence of color processing parameters. Consider the case where there are N possible sets of color processing parameters 342. The iterative training can be based on an exhaustive search that presents displays of the corresponding N processings of the color-blindness test image(s) 302. In this case, the termination criteria can correspond to the end of the exhaustive search—i.e., the completion of all N iterations. In other examples, the processing parameter adjustment subsystem 340 generates sets of color processing parameters 342 by iteratively adjusting the color processing parameters 342 via a tree search or other hierarchical search technique, a gradient search, DIRECT search, simulated annealing, generic algorithm or other search algorithm or optimization technique. In these cases, the termination criteria can correspond to a maximum iteration count, achieving a score that is above a performance threshold and/or after failing to improve the score after Y attempts or other termination criteria that is specific to the particular search algorithm employed. In any case, the final color processing parameters can then be selected based on the set of color processing parameters 342 that yielded the “best” score—e.g. that, based on the user feedback 344, has yielded the was most favorable color-blindness mitigation results for the viewer.

In further examples, the color processing subsystem 310 operates via digital compensation of a visible spectrum and the color processing parameters 342 include digital compensation parameters that result in the particular compensation applied to the frequencies in the visible spectrum. This digital compensation can be performed via one or more neural networks 399 as shown in FIG. 3C where the color processing parameters 342 can include, for example, the neuron interconnect topologies, synaptic weights and/or neuron functions of the one or more neural networks 399.

Consider that, in further examples, the color processing subsystem 310 and processing parameter adjustment subsystem 340 perform a user color vision assessment/profile from analyzing the user feedback 334 when sweeping the natural color spectrum. The results of such an iterative sweeping can be used to determine a final set of color processing parameters 342 corresponding to, for example, the gains at a plurality of different frequencies across the visible spectrum and/or other filter parameters. In addition or the alternative to any of the foregoing, this sweeping assessment or other iterative training can also identify the user's conflict regions in the natural color spectrum. Conflict regions are contiguous regions of the natural color spectrum where the colors in those regions appear color anomalous, i.e. color blind, to the user. Mitigation strategies for these deficiencies are user specific and final color processing parameters 342 can also be generated to incorporate various concepts such as applying an effective digital notch filter over the conflict regions (where wavelengths are blocked from display) and/or digitally transposing the wavelength signals from the conflict regions to non-conflict regions (in either an adjacent portion of the spectrum or other non-conflict region) as encompassed in the final color processing parameters. In this fashion, colors that may not otherwise be distinguished can be transposed into colors that are distinguishable to the particular user.

FIG. 3D is a pictorial representation of example screen displays in accordance with various embodiments. In particular, the series of color screen displays (132-1, 132-2 . . . 132-n) present displays of the corresponding to n processings of a particular color-blindness test image 302. Given the color-sensitive nature of these displays, color reproduction is necessary for a reader to properly differentiate these images.

FIG. 3E is a block/flow diagram of an example portion 300-2 of a color reproduction device in accordance with various embodiments. After the final color processing parameters 342-1 have been determined as a result of the iterative training, the color processing subsystem 310 can process color images 352 (e.g., media files that include text, color graphics, video and still images and other color imagery), based on these parameters to produce processed color images 354 for display to the user 130 via a display device 270 or other display device.

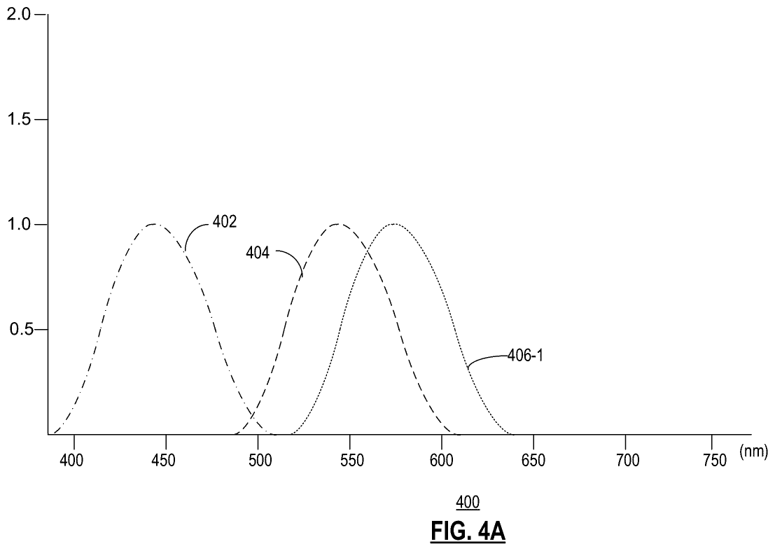

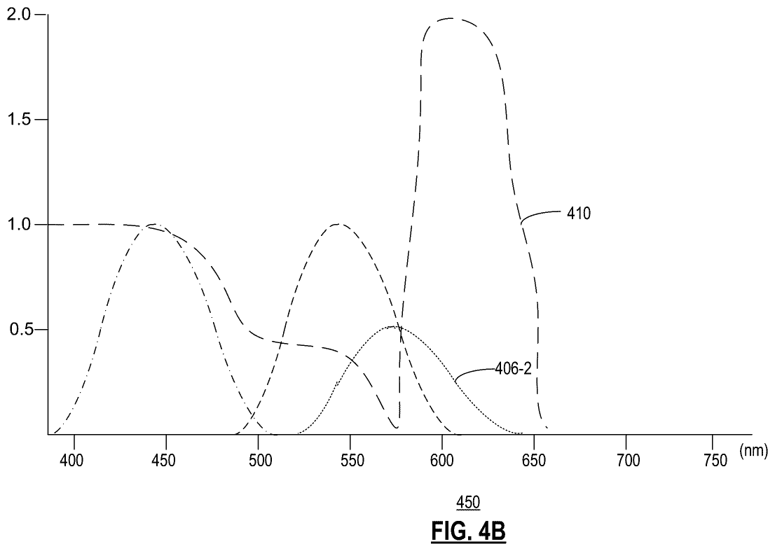

FIG. 4A is a graphical diagram of the color spectrum in accordance with various embodiments that presents sensitivity of a typical viewer without color-blindness vs. wavelength (in nanometers). This example indicates a blue wavelength/sensitivity 402, a green wavelength/sensitivity 404 and a red wavelength/sensitivity 406-1. FIG. 4B is a graphical diagram of the color spectrum in accordance with various embodiments corresponding to a viewer with color-blindness resulting from a reduced red sensitivity 406-2. In this circumstance, the color processing subsystem 310 has been trained to generate a color processing 410 to mitigate the effects of the viewer's color-blindness by: 1) substantially passing the blue spectrum, 2) by providing a notch in a region between the green and red spectra and 3) otherwise attenuating the green spectrum—while boosting the amplitude of a portion of the red spectrum to help compensate for the viewer's reduced red sensitivity.

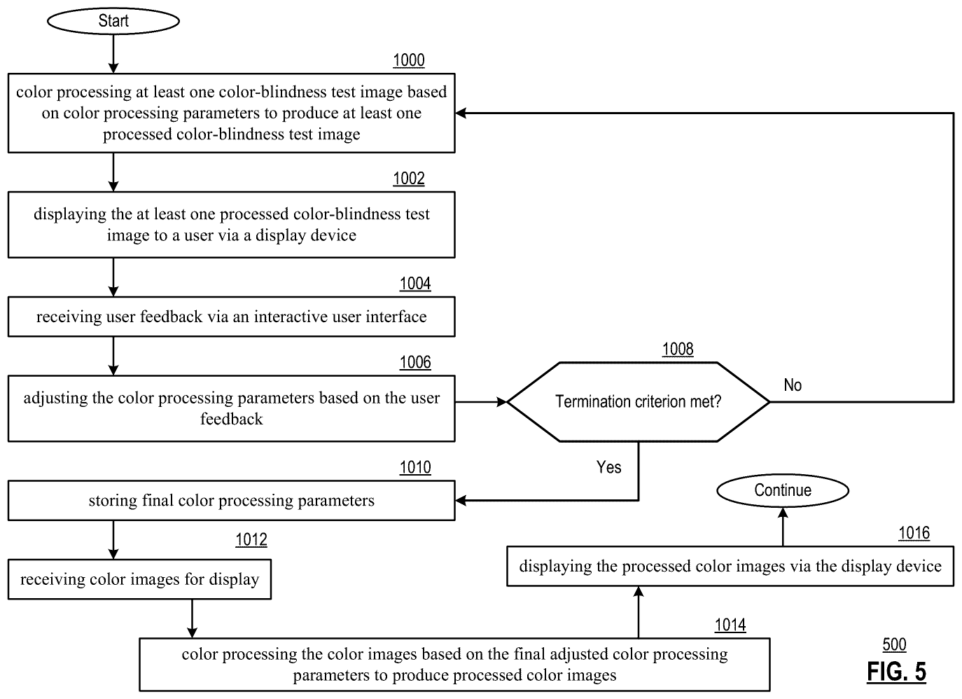

FIG. 5 is a flow diagram of an example method in accordance with various embodiments. In particular, a method 500 is presented for use with a color reproduction device 120 and/or any of the components, functions and/or features described therewith. Step 1000 includes color processing at least one color-blindness test image based on color processing parameters to produce at least one processed color-blindness test image. Step 1002 includes displaying the at least one processed color-blindness test image to a user via a display device. Step 1004 includes receiving user feedback via an interactive user interface. Step 1006 includes adjusting the color processing parameters based on the user feedback.

In decision step 1008 the method determines if the termination criterion has been met. If no, the method repeats steps 1000, 1002, 1004 and 1006. If yes, the method proceeds to step 1010 that includes storing final color processing parameters. Step 1012 includes receiving color images for display. Step 1014 includes color processing the color images based on the final color processing parameters to produce processed color images for display. Step 1016 includes displaying the processed color images via the display device.

In addition or in the alternative to any of the foregoing, the color processing operates via digital compensation of a visible spectrum and wherein the color processing parameters include digital compensation parameters.

In addition or in the alternative to any of the foregoing, the color processing operates via a plurality of color compensation engines and wherein the color processing parameters include compensation parameters corresponding to the plurality of color compensation engines.

In addition or in the alternative to any of the foregoing, the plurality of color compensation engines include a blue compensation engines, a red compensation engines and a green compensation engines and wherein the compensation parameters include gains corresponding to the blue compensation engines, the red compensation engines and the green compensation engines.

In addition or in the alternative to any of the foregoing, the plurality of color compensation engines include a notch compensation engines and wherein the compensation parameters include a notch frequency and a notch bandwidth corresponding to the notch compensation engines.

In addition or in the alternative to any of the foregoing, the color processing parameters are adjusted by selecting a next set of color processing parameters in a predetermined sequence of color processing parameters.

In addition or in the alternative to any of the foregoing, the color processing parameters are adjusted utilizing a search algorithm.

In addition or in the alternative to any of the foregoing, the termination criterion includes reaching a maximum iteration count.

In addition or in the alternative to any of the foregoing, the user feedback includes a score and wherein the termination criterion includes comparing the score to a threshold.

In addition or in the alternative to any of the foregoing, the user feedback includes a plurality of scores for the plurality of iterations and wherein the final color processing parameters correspond to the color processing parameters for one of the plurality of iterations yielding a most favorable score of the plurality of scores.

In addition or in the alternative to any of the foregoing, the color processing operates via one or more neural networks.

In addition or in the alternative to any of the foregoing, adjusting the color processing parameters includes sweeping a frequency window over a range of visible frequencies.

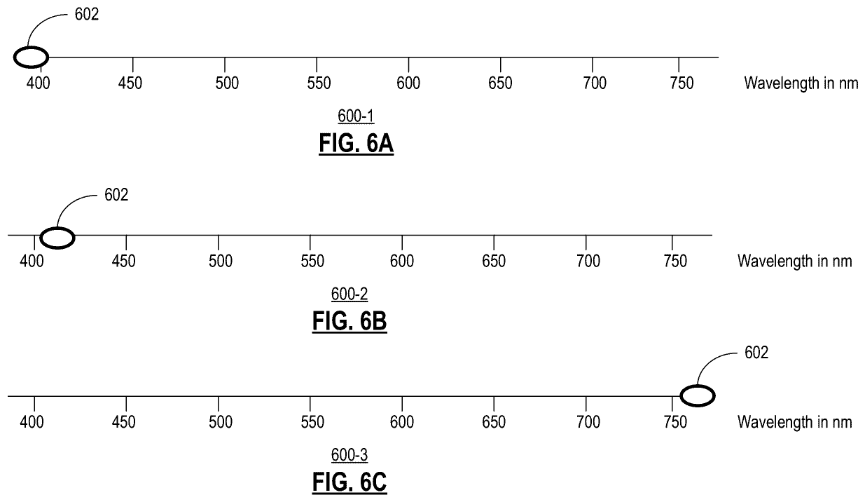

FIGS. 6A-6C are pictorial representations of portions of example screen displays in accordance with various embodiments. In addition or the alternative to any of the foregoing, the processing parameter adjustment subsystem operates by sweeping a limited-range frequency window across the range of visible frequencies. Color blindness test image(s) 302 are used to generate (via e.g., color processing subsystem 310) processed color-blindness test images(s) 312 corresponding to the limited ranges. User feedback 334 collected in this fashion can then be stored and used to generate the final color processing parameters 342-1.

In various examples, the user feedback can take the form of user indications whether or not the user could discern changes in the processed color-blindness test images(s) 312 from the prior window to the current window. Furthermore, the sweeping processing can proceed automatically with each successive frequency window being triggered by the receipt of user feedback from the prior frequency window. In the alternative, the sweeping process can be under user control with the user changing frequency windows via interaction with a user interface until to find and stop at (or otherwise indicate) either (a) one or more particular frequency windows that result in a discernable change or (b) one or more particular frequency windows that stop(s) yielding a change from the prior frequency window.

Considering specifically the example presented in FIG. 6A, a portion of a screen display displays a user interface that presents a graphical representation of the visible spectrum between 380 and 780 nm. In this example, the color spectrum (e.g., the full visible spectrum or some predetermined portion thereof) has been partitioned into k frequency windows of range of frequencies d. The position (and breadth) of the oval 602 correspond to the range of frequencies in the first such frequency window. As the frequency window advances to a second such window, either automatically or by user interaction with the oval 602, the position of the oval slides to correspond to the range of this new frequency window as shown in FIG. 6B. The process can continue across the entire spectrum until termination, as indicated, in FIG. 6C, where the oval 602 has reached the furthest extent of the color spectrum or other range of frequencies to be evaluated.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if signal A matches signal B can likewise be performed by determining −A matches −B or not (A) matches not (B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, wired or wireless, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A color reproduction device, comprising:
a display device;
an interactive user interface;
at least one processing system that includes a processor; and
at least one memory including a non-transitory computer readable storage medium that stores executable instructions corresponding to a color-blindness mitigation application that, when executed by the at least one processing system, cause performance of operations that include:
iteratively training a color processing subsystem, wherein the iterative training includes the steps of:
(a) color processing at least one color-blindness test image based on color processing parameters to produce at least one processed color-blindness test image;
(b) displaying the at least one processed color-blindness test image to a user via the display device;
(c) receiving user feedback via the interactive user interface;
(d) adjusting the color processing parameters based on the user feedback;
(e) repeating steps (a)-(d) via a plurality of iterations until a termination criterion is met; and
(f) storing final color processing parameters when the termination criterion is met;
receiving color images for display;
color processing the color images based on the final color processing parameters to produce processed color images for display via the display device.

2. The color reproduction device of claim 1, wherein the color processing operates via digital compensation of a visible spectrum and wherein the color processing parameters include digital compensation parameters.

3. The color reproduction device of claim 1, wherein the color processing operates via a plurality of color compensation engines and wherein the color processing parameters include compensation parameters corresponding to the plurality of color compensation engines.

4. The color reproduction device of claim 3, wherein the plurality of color compensation engines include a blue compensation engine, a red compensation engine and a green compensation engine and wherein the compensation parameters include gains corresponding to the blue compensation engine, the red compensation engine and the green compensation engine.

5. The color reproduction device of claim 3, wherein the plurality of color compensation engines include a notch compensation engine and wherein the compensation parameters include a notch frequency and a notch bandwidth corresponding to the notch compensation engine.

6. The color reproduction device of claim 1, wherein the color processing parameters are adjusted by selecting a next set of color processing parameters in a predetermined sequence of color processing parameters.

7. The color reproduction device of claim 1, wherein the color processing parameters are adjusted utilizing a search algorithm.

8. The color reproduction device of claim 1, wherein the termination criterion includes reaching a maximum iteration count.

9. The color reproduction device of claim 1, wherein the user feedback includes a score and wherein the termination criterion includes comparing the score to a threshold.

10. The color reproduction device of claim 1, wherein the user feedback includes a plurality of scores for the plurality of iterations and wherein the final color processing parameters correspond to the color processing parameters for one of the plurality of iterations yielding a most favorable score of the plurality of scores.

11. The color reproduction device of claim 1, wherein the color processing operates via one or more neural networks.

12. The color reproduction device of claim 1, wherein adjusting the color processing parameters includes sweeping a frequency window over a range of visible frequencies.

13. A method for implementation via at least one processing system that includes a processor, the method comprising:
(a) color processing at least one color-blindness test image based on color processing parameters to produce at least one processed color-blindness test image;
(b) displaying the at least one processed color-blindness test image to a user via a display device;
(c) receiving user feedback via an interactive user interface;
(d) adjusting the color processing parameters based on the user feedback;
(e) repeating steps (a)-(d) via a plurality of iterations until a termination criterion is met; and
(f) storing final color processing parameters when the termination criterion is met;
(g) receiving color images for display;
(h) color processing the color images based on the final color processing parameters to produce processed color images; and
(i) displaying the processed color images via the display device.

14. The method of claim 13, wherein the color processing operates via digital compensation of a visible spectrum and wherein the color processing parameters include digital compensation parameters.

15. The method of claim 13, wherein the color processing operates via a plurality of color compensation engines and wherein the color processing parameters include compensation parameters corresponding to the plurality of color compensation engines.

16. The method of claim 13, wherein the color processing operates via one or more neural networks.

17. The method of claim 13, wherein adjusting the color processing parameters includes sweeping a frequency window over a range of visible frequencies.

18. The method of claim 13, wherein the color processing parameters are adjusted by selecting a next set of color processing parameters in a predetermined sequence of color processing parameters.

19. The method of claim 13, wherein the color processing parameters are adjusted utilizing a search algorithm.

20. The method of claim 13, wherein the user feedback includes a plurality of scores for the plurality of iterations and wherein the final color processing parameters correspond to the color processing parameters for one of the plurality of iterations yielding a most favorable score of the plurality of scores.
